(19) United States
(12) Patent Application Publication
(10) Pub. No.: US 2013/0149163 A1
(43) Pub. Date: Jun. 13, 2013

(54) Method for Reducing Stress on Blade Tips

(71) Applicants: Joseph Parkos, JR., East Haddam, CT (US); Michael A. Weisse, Tolland, CT (US); Christopher S. McKaveney, Rocky Hill, CT (US); James R. Murdock, Tolland, CT (US); Scott C. Billings, Marlborough, CT (US)

(72) Inventors: Joseph Parkos, JR., East Haddam, CT (US); Michael A. Weisse, Tolland, CT (US); Christopher S. McKaveney, Rocky Hill, CT (US); James R. Murdock, Tolland, CT (US); Scott C. Billings, Marlborough, CT (US)

(73) Assignee: UNITED TECHNOLOGIES CORPORATION, Hartford, CT (US)

(21) Appl. No.: 13/324,169

(22) Filed: Dec. 13, 2011

(51) Int. Cl. F01D 5/14; B23P 15/02

(52) U.S. Cl. 416/224; 416/223 R; 416/241 R; 416/232; 29/889.7; 29/889.72

(57) ABSTRACT

A turbine engine component has an airfoil portion with a tip portion and the tip portion has at least one chamfered edge on one side. If desired, the tip portion may have a first chamfered edge on a first side and a second chamfered edge on a second side opposed to the first side. A flattened tip portion may extend between the first and second chamfered edges. A tip treatment may be applied to the flattened tip portion.

### BACKGROUND

The present disclosure relates to a blade tip having a chamfered configuration for reducing bending stress at the tip.

Many turbine engines have fans formed by a plurality of blades. In order to obtain better fan performance, an outer air seal is provided in the form of a rub strip. Occasionally, the fan blade will rub against the outer air seal rub strip. Blade tip treatments may be needed to provide an abrasive or hardened layer for rub resistance to the seal material to protect the fan blade. These treatments may cause a fatigue debit to the fan blade.

### SUMMARY

In accordance with the present disclosure, there is provided a turbine engine component which broadly comprises an airfoil portion with at least one chamfered edge on at least one side.

Further in accordance with the present disclosure, there is provided a method for creating a turbine engine component, which method broadly comprises forming a turbine engine component having an airfoil portion with a pressure side and a suction side and with at least one chamfered edge on one of the pressure side and the suction side.

Other details of the method for reducing stress on a fan blade tip are set forth in the following detailed description and the accompanying drawings wherein like reference numerals depict like elements.

### BRIEF DESCRIPTION OF THE DRAWINGS

FIG. 1 is a schematic diagram depicting an embodiment of a gas turbine engine;

FIG. 2 is a side view of a fan blade and an abradable outer seal;

FIG. 3 is a top view of a fan blade having a tip treatment or coating applied thereto; and

FIG. 4 is a mid-chord sectional view of the blade of FIG. 3.

### DETAILED DESCRIPTION

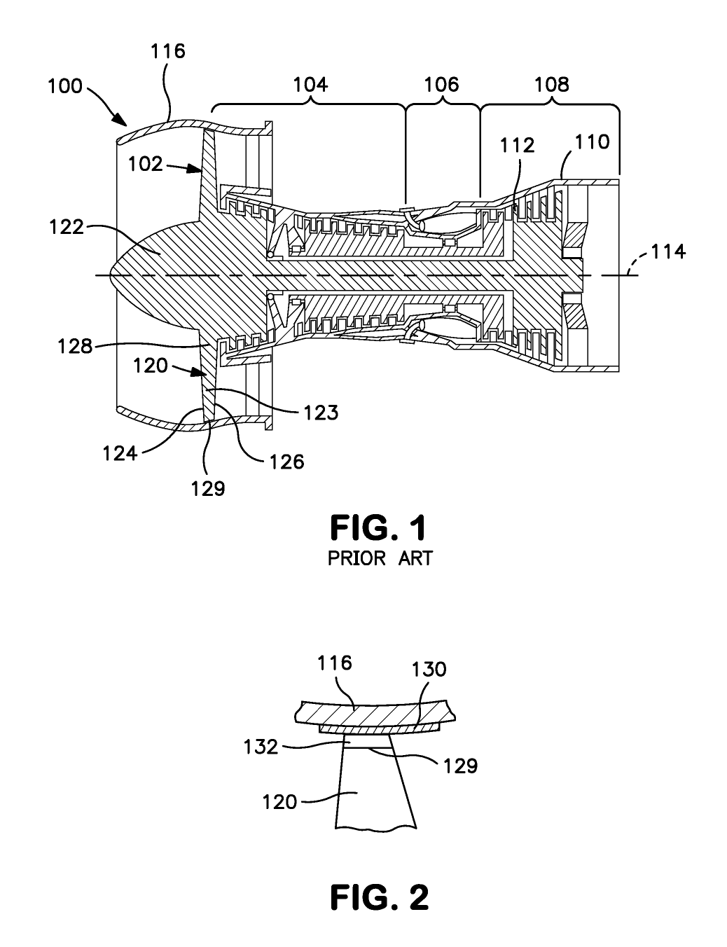

Referring now to the drawings, FIG. 1 is a schematic diagram depicting an exemplary embodiment of a gas turbine engine. As shown in FIG. 1, engine 100 incorporates a fan 102, a compressor section 104, a combustion section 106, and a turbine section 108. Various components of the engine are housed within an engine casing 110 that extends along a longitudinal axis 114. The fan 102 is housed within a casing 116.

The fan 102 consists of a plurality of fan blades 120 which are mounted to a disk 122. Each of the fan blades 120 has an airfoil portion 123 with a leading edge 124, a trailing edge 126, a root portion 128, and a tip portion 129. Each fan blade 120 is attached to the disk 122 at the root portion 128. The fan blades 120 may be formed from any suitable material known in the art. For example, the fan blades 120 may be formed from an aluminum alloy. If desired, the fan blades 120 may be hollow.

If desired, as shown in FIG. 2, the fan casing 116 may be provided with an abradable rub strip 130. The rub strip 130 may be formed from any suitable material known in the art. In order to protect the tip portion 129 of the fan blade 120, a tip treatment or coating 132 may be applied. The tip treatment or coating 132 provides a surface that is capable of a rub against the abradable rub strip 130 as well as providing a barrier to corrosion of the base fan blade material. The tip treatment or coating 132 can be, but is not limited to, a hard anodized coating, an anodized coating, a plasma coating, or a plated coating. The hard coating may be a coating which results from converting the base material of the fan blade 120, typically aluminum or an aluminum alloy, to a dense aluminum oxide coating. For some hard coatings, the coating may be impregnated with Teflon. A typical anodized coating may be an aluminum oxide, which is not as dense or thick as the hardcoat. The primary function of the coating is corrosion protection; however, some wear resistance is provided. A suitable plasma coating would be a two part system that has a ceramic topcoat. Plated coatings include those that are inexpensive, readily available, easily plated, compatible with aluminum, and viable as a rub material. Such plated coatings may comprise nickel and cobalt or an alloy of these two metals. The coating may also comprise a hard abrasive material.

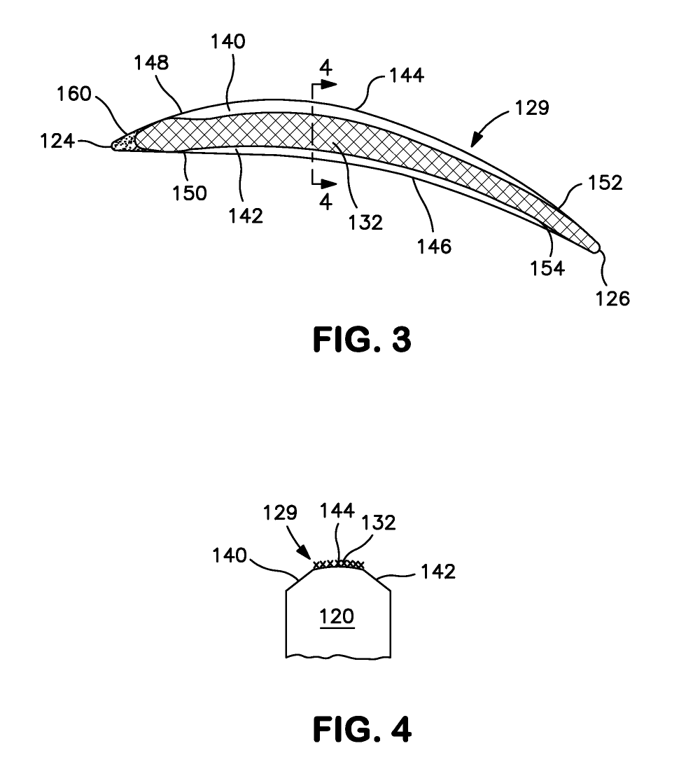

Referring now to FIGS. 3 and 4, in order to reduce the peak bending stress at the tip portion 129 of the fan blade 120 at least one chamfered edge 140 or 142 is provided on the tip portion 129. Adjacent the chamfered edge 140 or 142 is a flattened portion 144.

In a useful embodiment, the tip portion 129 is provided with two chamfered edges 140 and 142. The chamfered edges 140 and 142 are cut so as to leave a flat portion 144 therebetween.

The tip treatment or coating 132 is applied to the flat portion 144 of the modified blade tip portion 129. Each chamfered edge 140 and 142 may be as large as possible because larger chamfers lead to more stress reduction. The size is limited however by the need to maintain a minimum amount of flat portion 144 at the tip in order to have a surface capable of an effective tip gap and/or rub,

As can be seen from FIG. 3, the chamfered edge 140 may be located along the suction side 144 of the fan blade 120 and the chamfered edge 142 may be located along the pressure side 146 of the fan blade 120. Each of the chamfered edges 140 and 142 begins at a point 148 and 150 respectively spaced from the leading edge 124 of the fan blade. Each chamfered edge 140 and 142 extends to a point 152 and 154 respectively spaced from the trailing edge 126 of the fan blade 120. At the points 148, 150, 152 and 154, the chamfered edges 140 and 142 are blended into the pressure and suction sides 144 and 146. The distance from the leading edge 124 of the fan blade or the trailing edge 126 of the fan blade to the chamfered edges 140 and 142 is determined based on modeshape and the stress distribution associated with it of any vibratory mode of concern where bending is present at the tip. Each of the chamfers 140 and 142 may exist at and around the peak stress chordwise location or locations so that the stress reduction is achieved.

In order to ensure a smooth flow of air over the pressure and suction sides 146 and 144 respectively, a sheath 160 may be placed over the leading edge 124 of the fan blade 120. The sheath 160 may be formed from a metal selected from the group consisting of titanium, nickel, steel, alloys of the foregoing, and any material more erosion-resistant than the material forming the fan blade 120.

Each chamfered edge 140 or 142 may be cut to have a radius or may be cut straight to create a setback of the corner and reduce the peak bending stress at the tip portion 129 where the tip treatment or coating 132 may be applied. The radius of each chamfered edge 140 and 142 or the straight cut of each chamfered edge 140 and 142 should be such as to create the flat tip portion 129. The provision of the chamfered edges 140 and 142 reduces the peak bending stress by moving the stress points away from the tip edge. This effectively restores the fatigue strength back to the original substrate. The radius, when sued, also provides a surface that will enable treatments such as a hardcoat which has a propensity for cracking if a break edge is not provided. The value of the radius and the size of the flat tip portion 129 may be determined by which treatment is selected and overall blade requirements.

The fan blade 120 of the present disclosure may be manufactured using any desired technique. For example, the fan blade 120 with the chamfered edges 140 and 142 may be manufactured using an investment casting technique in which the chamfered edge 140 and/or 142 are integrally formed with the remainder of the fan blade 120. Alternatively, the fan blade 120 without the chamfered edges 140 and/or 142 may be manufactured using any suitable casting technique known in the art. After the fan blade 120 is cast, the chamfered edges 140 and/or 142 may be formed using any suitable cutting technique known in the art to form the edges 140 and/or 142 with a straight cut or a radius and to form the flattened tip portion 129.

After the tip portion 129 is formed, the tip treatment or coating 132 may be applied using any suitable technique known in the art.

While the present disclosure has focused on fan blades, it should be recognized that the chamfered edges described herein may be applied to other types of blades and to vanes.

There has been described in accordance with the instant disclosure a method for reducing stress on a blade tip. While the method set forth herein has been described in the context of a particular embodiment, other unforeseeable alternatives, modifications, and variations may become apparent to those skilled in the art. Accordingly, it is intended to embrace those alternatives, modifications, and variations as fall within the broad scope of the appended claims.

What is claimed is:

1. A turbine engine component comprising:
an airfoil portion with a tip portion; and
said tip portion having at least one chamfered edge on at least one side.

2. The turbine engine component of claim 1, further comprising said at least one chamfered edge being a straight cut.

3. The turbine engine component of claim 1, further comprising said at least one chamfered edge having a radius.

4. The turbine engine component of claim 1, wherein said tip portion has a first chamfered edge on a first side and a second chamfered edge on a second side opposed to said first side.

5. The turbine engine component of claim 4, further comprising a flattened tip portion extending between said first chamfered edge and said second chamfered edge.

6. The turbine engine component of claim 5, further comprising a tip treatment applied to said flattened tip portion.

7. The turbine engine component of claim 6, wherein said tip treatment comprises one of a hard anodized coating, an anodized coating, a plasma coating, and a plated coating.

8. The turbine engine component of claim 1, wherein said airfoil portion has a leading edge and said at least one chamfered edge begins at a distance from the leading edge.

9. The turbine engine component of claim 1, wherein said airfoil portion has a trailing edge and said at least one chamfered edge terminates at a distance from the trailing edge.

10. The turbine engine component of claim 1, wherein said turbine engine component comprises a fan blade.

11. The turbine engine component of claim 9, wherein said fan blade is made from an aluminum alloy.

12. The turbine engine component of claim 9, wherein said fan blade is hollow.

13. The turbine engine component of claim 1, wherein said airfoil portion has a leading edge and further comprises a sheath placed over said leading edge.

14. A method for creating a turbine engine component, said method comprising forming a turbine engine component having an airfoil portion with a pressure side and a suction side and with at least one chamfered edge adjacent one of said pressure side and said suction side.

15. The method of claim 14, wherein said forming step comprises forming said at least one chamfered edge as a cast structure.

16. The method of claim 14, wherein said forming step comprises forming said at least one chamfered edge as a machined structure.

17. The method of claim 14, wherein said forming step comprises forming said at least one chamfered edge to have a radius.

18. The method of claim 14, wherein said forming step comprises forming said at least one chamfered edge to have a straight edge.

19. The method of claim 14, wherein said forming step comprises forming said at least one chamfered edge to extend chordwise from a point a distance away from a leading edge of said airfoil portion.

20. The method of claim 14, wherein said forming step further comprises forming said at least one chamfered edge to extend to a point spaced from a trailing edge of said airfoil portion.

21. The method of claim 14, wherein said forming step further comprises forming said turbine engine component to be hollow.

22. The method of claim 14, wherein said forming step comprises forming said turbine engine component to be a fan blade.

23. The method of claim 14, further comprising forming a flattened tip portion adjacent said at least one chamfered edge.

24. The method of claim 23, further comprising applying a tip treatment to said flattened tip portion.

25. The method of claim 14, further comprising placing a sheath over a leading edge portion of said airfoil portion.

26. The method of claim 14, wherein said forming step comprises forming a first chamfered edge adjacent said pressure side, a second chamfered edge adjacent said suction side, and a flattened portion between said first and second chamfered edges.
